(19) United States
(12) Patent Application Publication
(10) Pub. No.: US 2022/0273969 A1
(43) Pub. Date: Sep. 1, 2022

(54) WIRELESS VOICE COMMUNICATION FOR A SELF-CONTAINED BREATHING APPARATUS (SCBA)

(71) Applicant: 3M INNOVATIVE PROPERTIES COMPANY, St. Paul, MN (US)

(72) Inventor: Darin K. Thompson, Huntersville, NC (US)

(21) Appl. No.: 17/633,130

(22) PCT Filed: Aug. 4, 2020
(86) PCT No.: PCT/IB2020/057373

§ 371 Date: Feb. 4, 2022

Related U.S. Application Data
(60) Provisional application No. 62/884,307, filed on Aug. 8, 2019.

(51) Int. Cl. A62B 9/02; G08B 7/06; H04R 1/08; H04R 3/04; G10L 25/90; G10L 25/21; G06F 3/16; H04R 1/02; G10L 21/0232; A62B 9/00

(52) U.S. Cl. CPC A62B 9/022; G08B 7/06; H04R 1/08; H04R 3/04; G10L 25/90; G10L 25/21; G06F 3/165; H04R 1/028; G10L 21/0232; A62B 9/006; H04R 2420/07

(57) ABSTRACT

In one or more embodiments, a mask configured for fluid communication with a fluid reservoir is provided. The mask includes a fluid regulator in fluid communication with the fluid reservoir where the fluid regulator is configured to regulate fluid flow. The fluid regulator includes a wireless communication unit configured to transmit and receive communication signals and a first indicator configured to generate a haptic output where the haptic output is generated based on a first frequency. The fluid regulator includes an audio capture device configured to capture audible signals and microcontroller unit configured to sample, at a second frequency, the audible signals where the second frequency is based at least in part on the first frequency, and cause the sampled audible signals to be transmitted by the wireless communication unit.

### FIELD

The present technology is generally related to personal protective equipment such as self-contained breathing apparatus (SCBA) equipment, and in particular to reducing the effects of various noise sources on audio quality associated with the personal protective equipment.

### BACKGROUND

Personal protective equipment such as self-contained breathing apparatuses (SCBAs) may be used in environments where individuals are exposed to hazardous materials, such as gases, vapors, aerosols (e.g., dusts, mists, and/or biological agents), and/or the like, as is generally known in the art. The personal protective equipment may include an end of service time indicator (EOSTI) that indicates that one or more components of the personal protective equipment is at or is approaching a situation where the one or more components/equipment is no longer effective. For example, the sorbent associated with the personal equipment is approaching saturation such that one or more components of the personal protective equipment may lose its effectiveness to keep the user/first responder safe.

Activating the EOSTI to provide an indication to the user/first responder that is using the personal protective equipment may therefore be important as the user may be in a hazardous environment with limited effective life remaining in the personal protective equipment. However, while existing personal protective equipment may activate an EOSTI, the EOSTI may not be heard by the user or may overpower audio communications to the point where the audio communications are inaudible, thereby hindering communication with other users/first responders. Further, there may be additional noise sources that can contribute to making the audio communications inaudible, thereby compounding the problem with the activated EOSTI based noise. Therefore, existing personal protective equipment suffers from various voice communication issues.

### SUMMARY

The techniques of this disclosure generally relate to reducing the effects of various noise sources on audio quality associated with the personal protective equipment such as to, for example, allow EOSTI activation while allowing audible communication with less noise than in existing systems. In particular, activation of EOSTI may reduce the quality of audio/voice signals to be communicated as an EOSTI may generate noise such as mechanical vibration noise, e.g., haptic feedback, that introduces noise into captured audio signals, i.e., captured voice signals. Further, there may exist noise sources other than the EOSTI that may contribute to the audible noise captured by the SCBA during voice communications. The instant invention solves the problems with existing systems by one or more hardware and/or software configurations described herein, thereby allowing for audio communication with reduced noise while the end of service life indicator is activated.

According to one aspect of the disclosure, a mask configured for fluid communication with a fluid reservoir is provided. The mask includes a fluid regulator in fluid communication with the fluid reservoir where the fluid regulator is configured to regulate fluid flow. The fluid regulator includes a communications interface configured to transmit and receive communication signals and a first indicator configured to generate a haptic output where the haptic output is generated based on a first frequency. The fluid regulator includes an audio capture device configured to capture audible signals, and a microcontroller unit configured to sample, at a second frequency, the audible signals where the second frequency is based at least in part on the first frequency and cause the sampled audible signals to be transmitted by the wireless communication unit.

According to one or more embodiments of this aspect, the first frequency is set to less than 16 Hertz. According to one or more embodiments of this aspect, the second frequency is 25 Hertz. According to one or more embodiments of this aspect, the first indicator generates, at the first frequency, the haptic output, the haptic output being audible mechanical vibration, the sampling, at the second frequency, of the audible signals being configured to generate at least one sample with less haptic based noise than another sample. According to one or more embodiments of this aspect, the fluid regulator includes a second indicator that is configured to generate an audible output, the audible output and haptic output indicating a service condition of the mask has been met.

According to one or more embodiments of this aspect, a resistor in electrical communication with the audio capture device where the resistor is configured to attenuate at least one audible signal and electrical noise captured by the audio capture device. According to one or more embodiments of this aspect, the mask includes a nose cup where the resistor is positioned inside the nose cup of the mask. According to one or more embodiments of this aspect, the first indicator is positioned proximate the audio capture device. According to one or more embodiments of this aspect, the captured audio signals include signals within a pitch frequency band and signals within a breath frequency band. The microcontroller unit is further configured to determine a pitch band energy of the signals within the pitch frequency band, determine breath band energy of the signals within the breath frequency band, and mute breath noise based at least in part on a ratio of the pitch band energy and breath band energy.

According to another aspect of the disclosure, a method performed by a mask is provided. The mask including a fluid regulator in fluid communication with a fluid reservoir where the fluid regulator is configured to regulate fluid flow. A haptic output is generated by a first indicator where the haptic output is generated based on a first frequency. Audible signals are captured by an audio capture device. The audible signals are sampled at a second frequency. The second frequency is set based at least in part on the first frequency. The sampled audible signals are caused to be transmitted by a wireless communication unit for communications.

According to one or more embodiments of this aspect, the first frequency is set to less than 16 Hertz. According to one or more embodiments of this aspect, the second frequency is 25 Hertz. According to one or more embodiments of this aspect, the first indicator generates, at the first frequency, the haptic output, the haptic output being audible mechanical vibration, the sampling, at the second frequency, of the audible signals being configured to generate at least one sample with less haptic based noise than another sample.

According to one or more embodiments of this aspect, an audible output is generated by a second indicator where the audible output and haptic output indicates a service condition of the mask has been met. According to one or more embodiments of this aspect, at least one audible signal and electrical noise captured by the audio capture device are attenuated using a resistor in electrical communication with the audio capture device. According to one or more embodiments of this aspect, the mask includes a nose cup where the resistor is positioned inside the nose cup of the mask.

According to one or more embodiments of this aspect, the mask includes a nose cup where the first indicator is positioned proximate the audio capture device. According to one or more embodiments of this aspect, the captured audio signals include signals within a pitch frequency band and signals within a breath frequency band. A pitch band energy of the signals within the pitch frequency band is determined. Breath band energy of the signals within the breath frequency band is determined. Breath noise is muted based at least in part on a ratio of the pitch band energy and breath band energy.

According to another aspect of the disclosure, a fluid regulator for a mask is provided. The fluid regulator is in fluid communication with a fluid reservoir. The fluid regulator is configured to regulate fluid flow. The fluid regulator includes a communications interface configured to transmit and receive communication signals and an end of service timer indicator (EOSTI) configured to generate a haptic output where the haptic output is generated based on a first frequency. The fluid regulator includes an audio capture device configured to capture audible signals, and a microcontroller unit configured to sample, at a second frequency, the audible signals where the second frequency is based at least in part on the first frequency and the first frequency is less than the second frequency, and cause the sampled audible signals to be transmitted by the wireless communication unit.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system according to the principles in the invention;

FIG. 2 is a block diagram of an example microcontroller unit according to the principles of the invention;

FIG. 3 is a block diagram of another example microcontroller unit according to the principles of the invention;

FIG. 4 is a flowchart of an exemplary process according to the principles of the invention;

FIG. 5 is a flowchart of another exemplary process according to the principles of the invention;

FIG. 6 is a flowchart of yet another exemplary process according to the principles of the invention; and

FIG. 7 is block diagram of an exemplary Fourier Transform of audio signals according to the principles of the invention.

### DETAILED DESCRIPTION

Before describing in detail example embodiments that are in accordance with the invention, it is noted that the embodiments reside primarily in combinations of components and processing steps related to personal protective equipment such as self-contained breathing apparatus (SCBA) equipment, and in particular to reducing the effects of various noise sources on audio quality associated with the personal protective equipment. Accordingly, components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication. For simplicity and ease of explanation, the invention will be described herein in connection with various embodiments thereof. Those skilled in the art will recognize, however, that the features and advantages of the invention may be implemented in a variety of configurations. It is to be understood, therefore, that the embodiments described herein are presented by way of illustration, not of limitation.

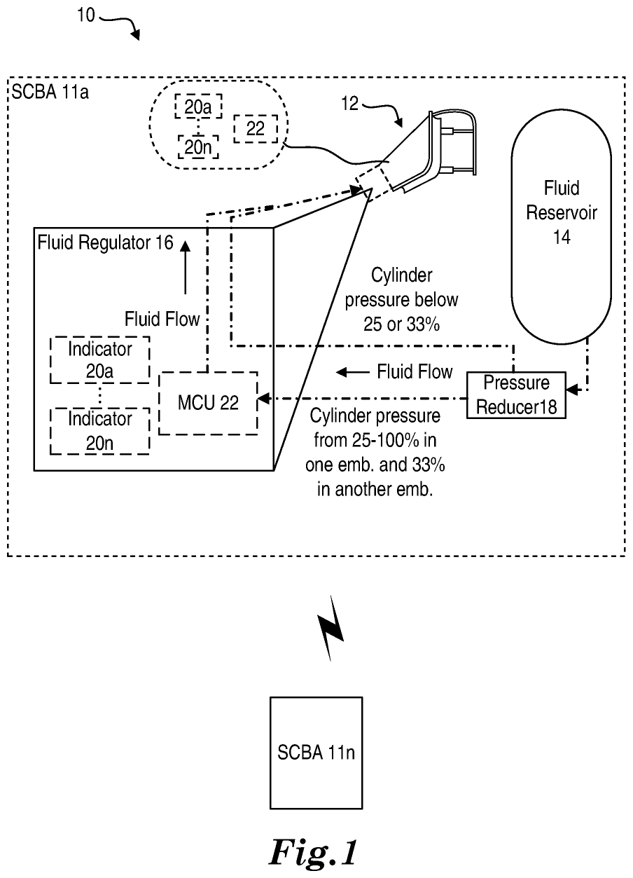

Referring now to drawing figures in which like reference designators refer to like elements there is shown in FIG. 1 an example system for providing determining information in accordance with the principles of the invention and designated generally as “10.” System 10 includes one or more self-contained breathing apparatuses (SCBAs) 11a-11n (collectively referred to as SCBA 11). In one or more embodiments, SCBA 11 may be in wireless communication with at least one other SCBA 11 and/or another device in system 10. SCBA 11 includes mask 12 for covering at least a portion of a first responder's face and for providing fluid, e.g., breathable air, from fluid reservoir 14 to the first responder as is known in the art. In one or more embodiments, mask 12 is in fluid communication with fluid reservoir 14 via fluid regulator 16 and pressure reducer 18. Fluid reservoir 14 is configured to store fluid and provide fluid to the user/first responder using SCBA 11.

Fluid regulator 16 is configured to regulate fluid flow to mask 12 and may be removably affixed to mask 12. In one or more embodiments, fluid regulator 16 is configured to provide at least one indication, via activation of one or more indicators 20a-20n. In particular, one or more indicators 20a-20n (collectively referred to as indicator 20) are configured to provide one or more indications such as one or more indications to the user/first responder using SCBA 11. In one or more embodiments, the indicator 20 may be an end of service life indicator (EOSTI) that indicates an end of service timer has been triggered, i.e, indicates at least one or more components of SCBA 11 are at or within a predefined range of the end of service life of the one or more components. In one or more embodiments, indicator 20 is a haptic based indicator configured to output haptic feedback for detection by a user. For example, indicator 20 may provide a vibration alert to indicate that SCBA 11 and/or at least one component of SCBA 11 has caused the triggering of at least one end of the EOSTI, i.e., indicator 20.

In one or more embodiments, the indicator 20 is configured to provide an indication at a predefined frequency. For example, in one or more embodiments, indicator 20 provides a vibration alert (i.e., haptic based indication) at a frequency of 15 Hz when activated. In one or more embodiments, indicator 20 is an audible indicator configured to provide audible feedback when activated. In one or more embodiments, the audible indicator may produce an audio signal if activated where activation may occur at a predefined frequency. Indicators 20 implemented in SCBA 11 may include one or more types of indicators 20 such as the indicators 20 discussed above and/or indicators 20 known in the art, but that may be configured as described herein.

In one or more embodiments, SCBA 11 and/or fluid regulator 16 includes microcontroller unit (MCU) 22 that is configured to help reduce the effects of various noise sources on audio quality associated with the personal protective equipment by, for example, implementing various component configurations and/or processes, as described herein. For example, MCU 22 may process audible signals from a first responder wearing a mask 12 such as to reduce the effects of audible noise generated by indicator 20, as described herein. In the same or different example, MCU 22 may process audible signals from a first responder wearing mask 12 such as to reduce the effects of audio noise generated by the first responder's breathing, as described herein.

Further, MCU 22 may be configured to activate and/or trigger one or more indicators 20 to indicate that SCBA 11 is at or near the end of service time for SCBA 11. For example, MCU 22 may trigger one or more indicators 20 based at least in part on one or more conditions being met. The MCU 22 may be configured to determine one or more characteristics of SCBA 11 such as fluid pressure, fluid flow rate, fluid level, etc., thereby allowing MCU 22 to compare these one or more characteristics to one or more predefined condition/thresholds. The one or more conditions may include one or more of at least one component of SCBA 11 functioning below a predetermined level/threshold, a fluid volume contained in fluid reservoir 14 being below a predefined volume threshold (i.e., low air reserves), etc.

While one or more components such as indicator 20, MCU 22, etc. are illustrated in FIG. 1 as being part of the fluid regulator 16, in one or more embodiments, one or more of these components and/or component functions may be implemented separately from fluid regulator 16 such as in a separate device and/or in another part of SCBA 11. For example, one or more indicators 20 may be positioned inside and/or affixed to mask 12 where MCU 22 may also be placed inside and/or affixed to mask 12. In other examples, indicator 20 and/or MCU 22 may be placed on other SCBA 11 equipment and/or affixed to the user/first responder using the SCBA 11. In one or more embodiments, indicator 20 and/or MCU 22 are placed proximate each other or separate from each other (such as on different components of SCBA 11) but may be in wireless and/or wired communication with each other.

SCBA 11 includes pressure reducer 18 that may be removably affixed to fluid reservoir 14 or fluid regulator 16. In one or more embodiments, pressure reducer 18 is configured to separate an incoming fluid flow into at least two fluid flows. The first fluid flow corresponds to a fluid reservoir 14 pressure below 25% in one embodiment and below 33% in another embodiment, while the second fluid flow corresponds to a fluid reservoir 14 pressure between 25-100% in one embodiment and at 33% in another. One or more characteristics of the second fluid flow may be determined by MCU 22, via one or more sensors (not shown), for determining whether to trigger one or more indicators 20. In one or more embodiments, the pressures described herein may satisfy one or more standards such as those standards described by the National Fire Protection Association (NFPA).

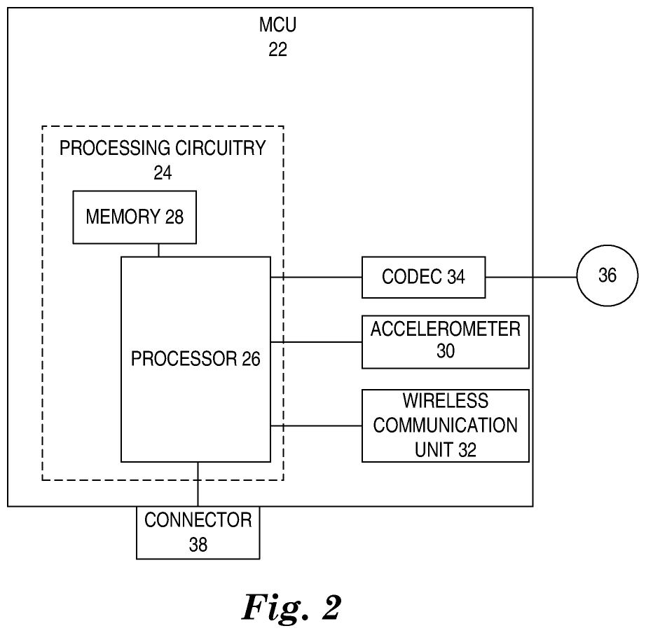

FIG. 2 is a block diagram of an example MCU 22 in accordance with the principles of the disclosure. MCU 22 includes various software and hardware for performing one or more MCU 22 functions described here. In one or more embodiments, MCU 22 includes processing circuitry 24. The processing circuitry 24 may include processor 26 and a memory 28. In particular, in addition to or instead of a processor, such as a central processing unit, and memory, the processing circuitry 24 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) the memory 28, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the MCU 22 further has software stored internally in, for example, memory 28, or stored in external memory (e.g., database, storage array, network storage device, etc.) accessible by the MCU 22 via an external connection. The software may be executable by the processing circuitry 24. The processing circuitry 24 may be configured to control any of the methods and/or processes described herein and/or to cause such methods, and/or processes to be performed, e.g., by MCU 22. Processor 26 corresponds to one or more processors 26 for performing SCBA 11 functions described herein. The memory 28 is configured to store data, programmatic software code and/or other information described herein. In some embodiments, the software stored in memory 28 may include instructions that, when executed by the processor 26 and/or processing circuitry 24, causes the processor 26 and/or processing circuitry 24 to perform the processes described herein with respect to MCU 22. For example, processing circuitry 24 of MCU 22 may be configured to perform one or more functions described herein such as one or more functions related to reducing the effects of one or more noise sources on audio quality associated with the personal protective equipment by operating one or more components of SCBA 11, as described herein, and/or processing audible signals as described herein.

MCU 22 further includes one or more accelerometers 30 that are configured to provide acceleration data to processor 26 to determine one or more characteristics associated with SCBA 11. MCU 22 further includes wireless communication unit 32 for transmitting and/or receiving wireless communication such as to and/or from another SCBA 11 according to one or more wireless communication standards, such as BLUETOOTH. MCU 22 includes one or more codecs 34 that are configured to encode and/or decode audible signals received from audio capture device 36. In one or more embodiments, MCU 22 is configured to communicate with one or more audio capture devices 36, via codec 34, for capturing audible signals such as capturing voice communication from the user/first responder using mask 12 and/or fluid regulator 16. In one or more embodiments, the audio capture device 36 is a microphone. In one or more embodiments, the audible signals captured by audio capture device 36 are sampled, by processing circuitry 24, based at least in part on one or more frequencies associated with indicator 20. For example, audible signals captured by audio capture device 36 are sampled by processing circuitry 24 and/or MCU 22 based at least in part on a vibration frequency of indicator 20, i.e., haptic based indicator. In one or more embodiments, the one or more frequencies associated with indicator 20 are set/configured based at least in part on the sampling frequency of the audible signals captured by audio capture device 36. For example, a vibration frequency of indicator 20, i.e., haptic based indicator, is set and/or configured based at least in part on a sampling frequency of audible signals captured by audio capture device 36. By advantageously setting the sampling frequency based at least in part on at least one indicator frequency (i.e., activation/triggering frequency) or vice-versa, the samples of the audible signals are captured with negligible indicator 20 based noise or no indicator 20 based noise.

MCU 22 may further include connector 38 to provide electrical communication for signals and power such as via one or more standardized connector configurations as is known in the art. In one or more embodiments, the illustrated communication lines in MCU 22 may include power communication lines and/or data/signal communication lines that are known in the art, e.g., USB and/or RS485 communication lines. Further, other components such as a AC to DC converters, voltage reference circuitry, etc., that are known in the art have been omitted from FIG. 2 for the sake a clarity.

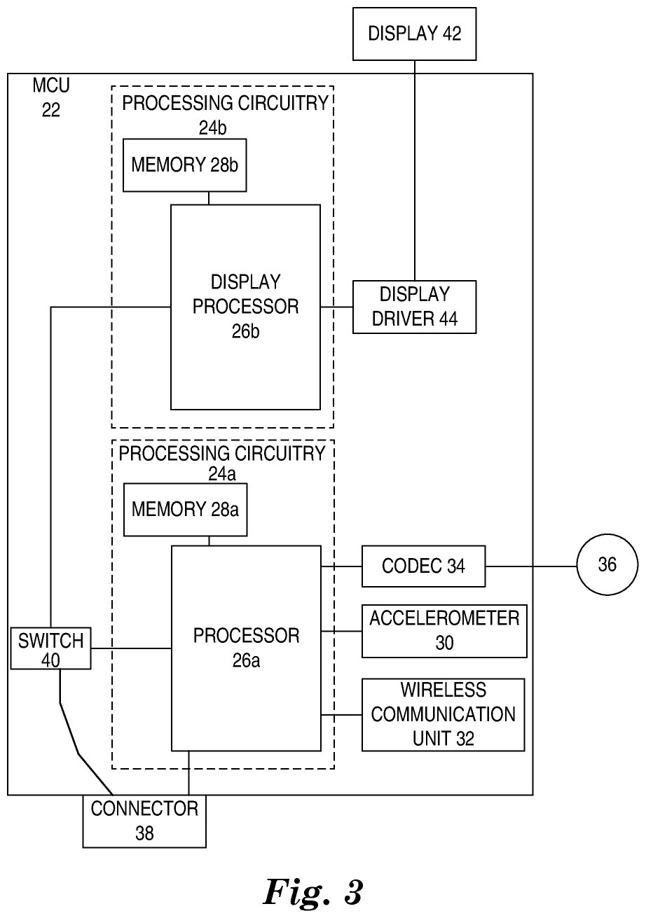

FIG. 3 is a block diagram of another example MCU 22 in accordance with the principles of the disclosure. MCU 22 in FIG. 3 can support displays such as a heads-up display within mask 12 in addition to the other functions and features described herein. MCU 22 includes processing circuitry 24a, processor 26a, accelerometer 30, wireless communication unit 32, codec 34 and audio capture device 36 as described above. MCU 22 further includes additional processing circuitry 24b including processor 26b and memory 28b, which are also described above, and switch 40 for switching data/signals among processing circuitry 24a and 24b. Processing circuitry 24b is configured to provide display processing and functionality for displaying information such as SCBA 11 information and/or EOSTI information on display 42 via display driver 44. In one or more embodiments, the illustrated communication lines in MCU 22 may include power communication lines and/or data/signal communication lines that are known in the art. Processing circuitry 24a and 24b, and their constituent components display processors 26a and 26b, and memory 28a and 28b need not be identical. In other words, processor 26a can be the same or a different type of processor from display processor 26b, and memory 28a can be the same or a different type of memory from memory 28b. Processors 26a and 26b are collectively described above as processor 26 with reference to FIG. 2. Similarly, memory 28a and memory 28b are collectively described above as memory 28 with reference to FIG. 2.

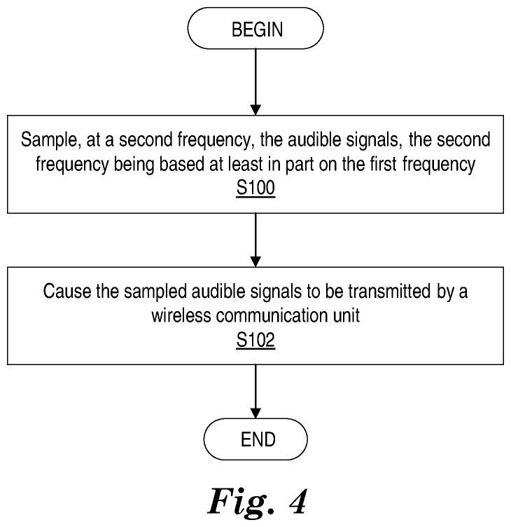

FIG. 4 is a flowchart of an exemplary process performed by MCU 22 and/or SCBA 11 for helping reduce the effects of various noise sources on audio quality associated with the personal protective equipment in accordance with the principles of the invention. In one or more embodiments, it may be assumed that indicator 20 is generating an output (e.g., haptic output, audible output, human perceptible output) that is based on a first frequency, and an audio capture device 36 is capturing audible signals such as for processing by processing circuitry 24 and/or MCU 22. One or more Blocks and/or functions performed by SCBA 11 may be performed by MCU 22, processing circuitry 24, processor 26, etc. In one or more embodiments, MCU 22 of SCBA 11 such as via one or more of processing circuitry 24 and/or processor 26 is configured to sample (Block S100), at a frequency (i.e., second frequency) the audible signals where the frequency is based at least in part on another frequency (i.e., first frequency) at which a haptic output is generated by indicator 20, as described herein. For example, the sampling frequency may be configured based on the activating/triggering frequency of indicator 20. In one or more embodiments, the frequency of a vibration alert generated by a haptic based indicator 20 may be configured to be less than existing systems such as to reduce the introduction of audible vibration based noise from indicator 20 into the sampled audio signals while still allowing sufficient haptic feedback to alert the user/first responder.

In one or more embodiments, at least one audible sample is processed by processing circuitry 24 and/or MCU 22 where the at least one audio sample includes no noise or negligible noise from one or more vibration mechanisms of one or more indicators 20. In one or more embodiments, the sample rate/frequency is 25 Hertz (Hz). In one or more embodiments, MCU 22 of SCBA 11 such as via one or more of processing circuitry 24, processor 26 is configured to cause (Block S102) the sampled audible signals to be transmitted by the wireless communication unit 32. In one or more embodiments, the sampled audible signals are transmitted to another SCBA 11 via wireless communication unit 32 where the sampled audible signals have negligible noise or no noise from the triggering of one or more indicators 20. Therefore, the configuration of sampling frequency with respect to the indicator 20 triggering frequency helps reduce the effects of one or more noise sources (i.e., indicator 20 based audible noise) on audio quality associated with the personal protective equipment.

According to one or more embodiments, the first frequency is set to less than 16 Hertz. According to one or more embodiments, the second frequency is 25 Hertz. According to one or more embodiments, the first indicator generates, at the first frequency, the haptic output, the haptic output being an audible mechanical vibration, the sampling, at the second frequency, of the audible signals being configured to generate at least one sample with less haptic based noise than another sample. According to one or more embodiments, the fluid regulator includes a second indicator that is configured to generate an audible output, the audible output and haptic output indicating a service condition of the mask has been met.

According to one or more embodiments, a resistor is in electrical communication with the audio capture device, the resistor configured to attenuate at least one audible signal and electrical noise captured by the audio capture device. According to one or more embodiments, the mask includes a nose cup, the resistor being positioned inside the nose cup of the mask. According to one or more embodiments, the first indicator is positioned proximate the audio capture device. According to one or more embodiments, the captured audio signals include signals within a pitch frequency band and signals within a breath frequency band. The micro controller unit is further configured to: determine a pitch band energy of the signals within the pitch frequency band, determine breath band energy of the signals within the breath frequency band, and mute breath noise based at least in part on a ratio of the pitch band energy and breath band energy.

According to one or more embodiments, a fluid regulator 16 for a mask 12 is provided. The fluid regulator 16 is in fluid communication with a fluid reservoir 14 where the fluid regulator 16 configured to regulate fluid flow. The fluid regulator 16 may include a wireless communication unit 32 configured to transmit and receive communication signals, an end of service timer indicator 20 (EOSTI) configured to generate a haptic output where the haptic output is generated based on a first frequency. The fluid regulator 16 may further include an audio capture device 36 configured to capture audible signals, and a microcontroller unit 22 configured to sample, at a second frequency, the audible signals where the second frequency is based at least in part on the first frequency and the first frequency is less than the second frequency, and cause the sampled audible signals to be transmitted by the wireless communication unit 32.

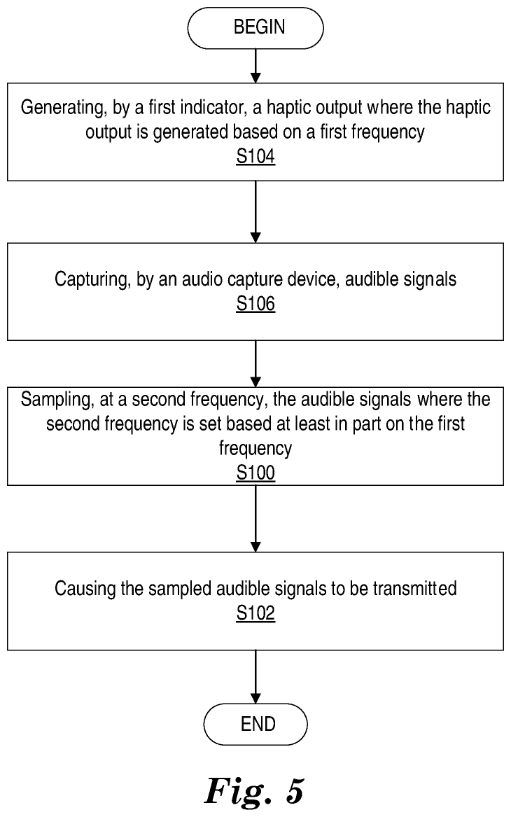

FIG. 5 is a flowchart of an exemplary process performed by MCU 22 and/or mask 12 and/or SCBA 11 for helping reduce the effects of various noise sources on audio quality associated with the personal protective equipment in accordance with the principles of the invention. In one or more embodiments, it may be assumed that indicator 20 is generating an output (e.g., haptic output, audible output, human perceptible output) that is based on a first frequency, and an audio capture device 36 is capturing audible signals such as for processing by processing circuitry 24 and/or MCU 22. In one or more embodiments, a haptic output is generated (Block S104) by a first indicator 20 where the haptic output is generated based on a first frequency, as described herein. In one or more embodiment, audible signals are captured (Block S106) by an audio capture device 36. Blocks S100 and S102 are the same as Blocks S100 and S102 described above with respect to FIG. 4.

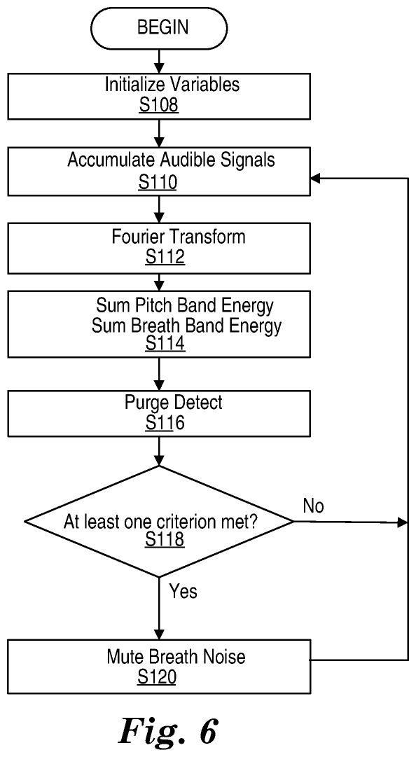

FIG. 6 is a flowchart of another exemplary process for reducing the effects of one or more noise sources on audio quality associated with the personal protective equipment. One or more Blocks and/or functions performed by MCU 22 and/or SCBA 11 may be performed by processing circuitry 24, processor 26, etc. In one or more embodiments, the audio capture device 36 (i.e., microphone) is placed in a nose cup of mask 12 such that the audio capture device 36 may capture voice communication from the first responder but may also capture audible noise caused by the first responder's breathing. In one or more embodiments, MCU 22 such as via one or more of processing circuitry 24 and processor 26 is configured to initialize (Block S108) variables, as described herein. In one or more embodiments, MCU 22 such as via one or more of processing circuitry 24 and processor 26 is configured to accumulate and/or receive (Block S110) audible signals from audio capture device 36, for example, as described herein

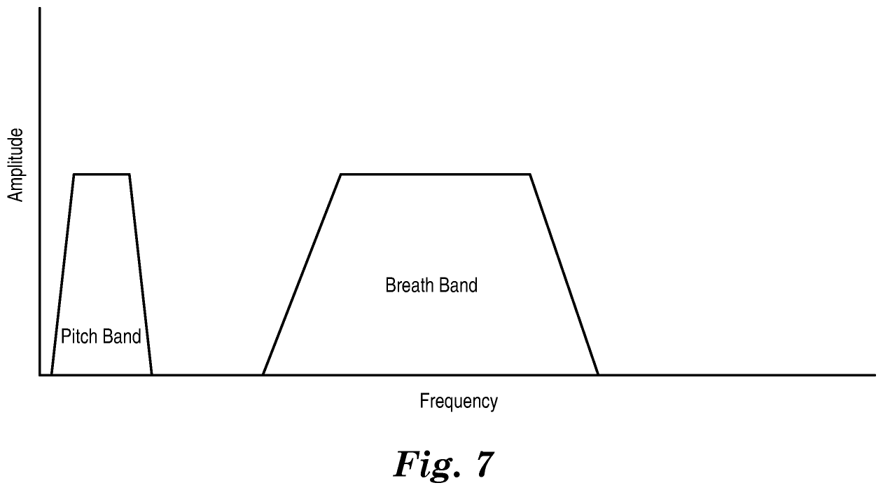

In one or more embodiments, MCU 22 such a via one or more of processing circuitry 24 and processor 26 is configured to perform a Fourier Transform (Block S112) on the audible signals captured by audio capture device 36, as described herein. An example of the Fourier Transform on one example of audible signals is illustrated in FIG. 7. In one or more embodiments, MCU 22 such as via one or more of processing circuitry 24 and processor 26 is configured to sum (Block S114) pitch band energy and sum breath band energy in the Fourier transform. The pitch band may correspond to a first frequency band of audible signals corresponding to voice signals captured by audio capture device 36 while the breath band energy may correspond to a second frequency band of audible signals corresponding to fluid flow noises captured by the audio capture device 36 such as breathing of the first responder and/or a fluid regulator 16 purge. In one or more embodiments, the first frequency band and second frequency band do not overlap. In one or more embodiments, MCU 22 such as via one or more of processing circuitry 24 and processor 26 is configured to determine (Block S116) a fluid regulator 16 purge has been detected such as based on activation of a trigger mechanism to initiate the purge and/or based on one or more characteristics of the audible signals captured by audio capture device 36. In one or more embodiments, a fluid regulator 16 purge may correspond to a constant increased flow of fluid from fluid reservoir 14 such as for clearing fog from mask 12, which may cause noise due to the fluid flow. In one or more embodiments, the fluid regulator 16 purge may be detected at least in part by counting and/or determining a quantity of purge noise frames in a predefined time window. If the quantity of purge noise frames exceeds a threshold, processing circuitry 24 may determine that a fluid regulator 16 purge has occurred. Otherwise, processing circuitry 24 may determine that a fluid regulator 16 purge did not occur.

In one or more embodiments, MCU 22 such as via one or more of processing circuitry 24 and processor 26 is configured to determine (Block S118) whether at least one predefined criterion is met. In one or more embodiments, the at least one criterion includes whether the breath band energy is greater than a threshold and whether the breath band energy divided by the pitch band energy is greater than a predefined ratio. In one or more embodiments, MCU 22 such as via one or more of processing circuitry 24 and processor 26 is configured to, if the at least one criterion is met, mute (Block S120) breath noise, as described herein. For example, in one or more embodiments, the breath frequency band may be muted (i.e., attenuated, filtered (e.g., low pass filter), etc.) such that the energy in the breath frequency band is reduced in the audible signals to be transmitted for voice communication. In one or more embodiments, the audio capture device 36 may be temporarily muted. Referring back to Block S118, if the at least one criterion is not met, fluid regulator 16 such as via one or more of processing circuitry 24 and processor 26 is configured to perform the function of Block S110.

Therefore, in one or more embodiments, the processing circuitry 24 is configured to determine a pitch band energy of the signals within the pitch frequency band, determine breath band energy of the signals within the breath frequency band, and mute breath noise based at least in part on a ratio of the pitch band energy and breath band energy.

FIG. 7 is an example of the results of applying a Fourier Transform to one example of accumulated audible signals as described in Block S112. As described above with respect to FIG. 6, signals in the breath band may be muted in order to help reduce the effects of various noise sources on audio quality associated with the personal protective equipment, as described herein. For example, breath noise, i.e., signals in the breath band may be muted based at least in part on a ratio of the pitch band energy and breath band energy.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A mask configured for fluid communication with a fluid reservoir, the mask comprising:
a fluid regulator in fluid communication with the fluid reservoir, the fluid regulator configured to regulate fluid flow, the fluid regulator comprising:
a wireless communication unit configured to transmit and receive communication signals;
a first indicator configured to generate a haptic output, the haptic output being generated based on a first frequency;
an audio capture device configured to capture audible signals; and
a microcontroller unit configured to:
sample, at a second frequency, the audible signals, the second frequency being based at least in part on the first frequency; and
cause the sampled audible signals to be transmitted by the wireless communication unit.

2. The mask of claim 1, wherein the first frequency is set to less than 16 Hertz.

3. The mask of claim 1, wherein the second frequency is 25 Hertz.

4. The mask of claim 1, wherein the first indicator generates, at the first frequency, the haptic output, the haptic output being an audible mechanical vibration, the sampling, at the second frequency, of the audible signals being configured to generate at least one sample with less haptic based noise than another sample.

5. The mask of claim 1, wherein the fluid regulator includes a second indicator that is configured to generate an audible output, the audible output and haptic output indicating a service condition of the mask has been met.

6. The mask of claim 1, further comprising a resistor in electrical communication with the audio capture device, the resistor configured to attenuate at least one audible signal and electrical noise captured by the audio capture device.

7. The mask of claim 6, wherein the mask includes a nose cup, the resistor being positioned inside the nose cup of the mask.

8. The mask of claim 6, wherein the first indicator is positioned proximate the audio capture device.

9. The mask of claim 6, wherein the captured audible signals include signals within a pitch frequency band and signals within a breath frequency band; and
the micro controller unit being further configured to:
determine a pitch band energy of the signals within the pitch frequency band;
determine breath band energy of the signals within the breath frequency band; and
mute breath noise based at least in part on a ratio of the pitch band energy and breath band energy.

10. A method performed by a mask, the mask including a fluid regulator in fluid communication with a fluid reservoir, the fluid regulator configured to regulate fluid flow, the method comprising:
generating, by a first indicator, a haptic output, the haptic output being generated based on a first frequency;
capturing, by an audio capture device, audible signals;
sampling, at a second frequency, the audible signals, the second frequency being set based at least in part on the first frequency; and
causing the sampled audible signals to be transmitted.

11. The method of claim 10, wherein the first frequency is set to less than 16 Hertz.

12. The method of claim 10, wherein the second frequency is 25 Hertz.

13. The method of claim 10, wherein the first indicator generates, at the first frequency, the haptic output, the haptic output being audible mechanical vibration, the sampling, at the second frequency, of the audible signals being configured to generate at least one sample with less haptic based noise than another sample.

14. The method of claim 10, further comprising attenuating at least one audible signal and electrical noise captured by the audio capture device using a resistor in electrical communication with the audio capture device.

15. The method of claim 14, wherein the mask includes a nose cup, the resistor being positioned inside the nose cup of the mask.

16. The method of claim 14, wherein the mask includes a nose cup, the first indicator being positioned proximate the audio capture device.

17. The method of claim 14, wherein the captured audible signals include signals within a pitch frequency band and signals within a breath frequency band; and
the method further comprising:
determining a pitch band energy of the signals within the pitch frequency band;
determining breath band energy of the signals within the breath frequency band; and
muting breath noise based at least in part on a ratio of the pitch band energy and breath band energy.

18. A fluid regulator for a mask, the fluid regulator being in fluid communication with a fluid reservoir, the fluid regulator configured to regulate fluid flow, the fluid regulator comprising:
a wireless communication unit configured to transmit and receive communication signals;
an end of service timer indicator (EOSTI) configured to generate a haptic output, the haptic output being generated based on a first frequency;
an audio capture device configured to capture audible signals; and
a microcontroller unit configured to:
sample, at a second frequency, the audible signals, the second frequency being based at least in part on the first frequency, the first frequency being less than the second frequency; and
cause the sampled audible signals to be transmitted by the wireless communication unit.

19. The fluid generator of claim 18, wherein at least one of:
the first frequency is set to less than 16 Hertz; and
the second frequency is 25 Hertz.

20. The fluid generator of claim 18, wherein the haptic output is an audible mechanical vibration, the sampling, at the second frequency, of the audible signals being configured to generate at least one sample with less haptic based noise than another sample.
